(19) United States
(12) Patent Application Publication
(10) Pub. No.: US 2006/0235146 A1
(43) Pub. Date: Oct. 19, 2006

(54) Dual reactor polyethylene resins for medical packaging - films, bags and pouches

(75) Inventors: Shivendra Kumar Goyal, Calgary (CA); Ishkmandeep Kaur Boparai, Calgary (CA)

Correspondence Address: Suzanne Kikel;NOVA Chemicals Inc., 400 Frankfort Rd., Monaca, PA, 15061, US

(73) Assignee: NOVA Chemicals (International) S.A.

(21) Appl. No.: 11/106,264

(22) Filed: Apr. 14, 2005

(51) Int. Cl. C08F 297/08; C08F 110/00

(52) U.S. Cl. 525/53; 526/348.1; 526/65

(57) ABSTRACT

Medical packaging films, bags and pouches having excellent optical properties and heat sealability, low hexane extractables and a good balance of physical properties may be prepared from linear low density polyethylene having a melt flow ratio (I₂₁/I₂) from about 23 to about 32, prepared in a tandem dual reactor solution phase polymerization in the presence of a phosphinimine catalyst and a co-catalyst system which comprises an aluminum based co-catalyst, an ionic activator or a mixture thereof.

### FIELD OF THE INVENTION

The present invention relates to polyethylene films, bags and pouches for medical packaging. More particularly the present invention relates to medical films, bags and pouches having good optical properties, low hexane extractables, excellent hot tack strength and sealability, and a good balance of puncture resistance, dart impact strength, machine direction tear and transverse direction tear strengths.

### BACKGROUND OF THE INVENTION

Films made from resins and particularly polyethylene resins manufactured using metallocene catalysts have higher dart impact strengths than the films made using Ziegler-Natta (Z-N) resins. However, such metallocene resins tend to have a number of drawbacks including their difficulty in conversion to finished products and the tendency for films made from these resins to split in the machine direction. It is desirable to produce a resin and particularly polyethylene having a good balance of properties and which is relatively easy to process or convert into finished products.

One approach has been to blend resins and particularly polyethylenes made using different types of catalyst such as a dry blend of a polyethylene made using a Ziegler-Natta catalyst and a polyethylene made using a metallocene catalyst or a single site catalyst. However, dry blending resin typically requires at least one additional pass of the component resins together through an extruder to form pellets of the blended resin. This can be costly particularly when one of the resins is difficult to process (e.g. the resin produced using the metallocene catalyst).

An alternate approach to avoid dry blending is the use of mixed catalyst systems in a single reactor. For example, U.S. Pat. No. 4,530,914 (Ewen et al., to Exxon) teaches the use of two different metallocenes in a single reactor, and U.S. Pat. No. 4,701,432 (Welborn, to Exxon) teaches the use of a supported catalyst prepared with a metallocene catalyst and a Ziegler Natta catalyst. Many others have subsequently attempted to use similar mixed catalyst systems as described in U.S. Pat. Nos. 5,767,031; 5,594,078; 5,648,428; 4,659,685; 5,145,818; 5,395,810; and 5,614,456.

However, the use of “mixed” catalyst systems is generally associated with operability problems. For example, the use of two catalysts on a single support (as taught by Welborn in U.S. Pat. No. 4,701,432) may be associated with a reduced degree of process control flexibility (e.g. if the polymerization reaction is not proceeding as desired when using such a catalyst system, then it is difficult to establish which corrective action should be taken as the corrective action will typically have a different effect on each of the two different catalyst components). Moreover, the two different catalyst/co-catalyst systems may interfere with one another—for example, the organoaluminum component, which is often used in Ziegler-Natta or chromium catalyst systems, may “poison” a metallocene catalyst.

U.S. Pat. No. 6,372,864 issued Apr. 16, 2002 to Brown teaches a dual reactor solution process for preparing a polyethylene in the presence of a phosphinimine catalyst and different co-catalysts in the first and second reactors. It discloses that some of the resulting polymers have a good balance of properties. However, the patent does not expressly teach any specific end use applications. Nor does the patent teach that by controlling the melt flow ratio (i.e. the ratio of I₂₁/I₂) or selecting a resin having a melt flow ratio from 23 to 32, preferably from 25 to 30 for such a resin, there is a convergence in the maxima or a good balance in a number of physical properties such as dart impact strength, tear strength in the machine direction (MD) and the direction perpendicular to the machine direction (transverse direction—TD) tear and puncture resistance, along with optical properties such as Haze and Gloss, hexane extractables and heat sealability such as hot tack strength and cold seal strength.

The present invention seeks to provide medical films, bags and pouches having a good balance of physical properties, lower hexane extractables and excellent optical properties, excellent hot tack strength and sealability and which are relatively easy to manufacture or process.

### SUMMARY OF THE INVENTION

The present invention provides a medical film, bag or pouch made from a linear low density polyethylene having a density from 0.914 to 0.945, preferably from 0.915 to 0.926 g/cm³ and a melt flow ratio (MFR=I₂₁/I₂) determined according to ASTM D 1238 from 23 to 32 prepared by A) polymerizing ethylene optionally with one or more C₃₋₁₂ alpha olefins, in solvent in a first stirred polymerization reactor at a temperature of from 80 to 200° C. and a pressure of from 10,500 to 35,000 KPa, (1,500 to 5,000 psi) in the presence of (a) a catalyst which is an organometallic complex of a group 3, 4 or 5 metal, characterized by having at least one phosphinimine ligand; and (b) a co-catalyst which is selected from the group consisting of an aluminoxane, an ionic activator or a mixture thereof; and B) passing said first polymer solution into a second stirred polymerization reactor at a pressure from 10,500 to 35,000 KPa (1,500 to 5,000 psi) and a temperature at least 20° C higher than the first reactor and polymerizing further ethylene, optionally with one or more C₃₋₁₂ alpha olefins, in said second stirred polymerization reactor in the presence of (a) a catalyst which is an organometallic complex of a group 3, 4 or 5 metal, characterized by having at least one phosphinimine ligand; and (b) a co-catalyst which is selected from the group consisting of an aluminoxane, an ionic activator or a mixture thereof; said polyethylene when formed into a film at a blowup ratio from 2.0 to 4.0 and a thickness from 0.5 to 6.0 mils using a blown film line at a production rate that is greater than 6 typically 6 to 30 lbs per hour per inch of die circumference, has good optical properties, heat sealability, low hexane extractables and a good of balance of dart impact strength, MD tear strength, TD tear strength and puncture energy.

### BRIEF DESCRIPTION OF THE DRAWINGS

FIG. 1 shows the GPC profiles of the resins used in the experiments.

FIG. 2 shows the processing characteristics of the resins used in the experiments.

FIG. 3 shows the Haze of 0.75 mil films made from the resins used in the experiments at a blow up ratio of 2.5.

FIG. 4 shows the Gloss 45° of 0.75 mil films made from the resins used in the experiments at a blow up ratio of 2.5.

FIG. 5 shows the Hexane extractables of 3.5 mil films made from the resins used in the experiments at a blow up ratio of 2.5.

FIG. 6 shows the Hot Tack profiles of 2.0 mil films made from the resins used in the experiments at a blow up ratio of 2.5.

FIG. 7 shows the Cold Seal profiles of 2.0 mil films made from the resins used in the experiments at a blow up ratio of 2.5.

FIG. 8 shows the dart impact strengths of 0.75 mil films made from the resins used in the experiments at a blow up ratio of 2.5 and a production rate of 16 lbs/hr/inch (2.8 kg/hr/cm) of die circumference.

FIG. 9 shows the machine direction (MD) tear strengths of 0.75 mil films made from the resins used in the experiments at a blow up ratio of 2.5 and a production rate of 16 lbs/hr/inch (2.8 kg/hr/cm) of die circumference.

FIG. 10 shows the puncture energy of 0.75 mil films made from the resins used in the experiments at a blow up ratio of 2.5 and a production rate of 16 lbs/hr/inch (2.8 kg/hr/cm) of die circumference.

FIG. 11 shows the dart impact strengths of 0.75 mil films made from three dual reactor bimodal single site resins used in the experiments at the blow up ratios of 2.5 and 3.5 and the production rates of 12 lbs/hr/inch (2.1 kg/hr/cm) and 16 lbs/hr/inch (2.8 kg/hr/cm) of die circumference.

FIG. 12 shows the MD tear strength of 0.75 mil films made from three dual reactor bimodal single site resins used in the experiments at the blow up ratios of 2.5 and 3.5 and the production rates of 12 lbs/hr/inch (2.1 kg/hr/cm) and 16 lbs/hr/inch (2.8 kg/hr/cm) of die circumference.

FIG. 13 shows the transverse direction (TD) tear strengths of 0.75 mil films made from three dual reactor bimodal single site resins used in the experiments at the blow up ratios of 2.5 and 3.5 and the production rates of 12 lbs/hr/inch (2.1 kg/hr/cm) and 16 lbs/hr/inch (2.8 kg/hr/cm) of die circumference.

FIG. 14 shows the effect of blow up ratio (BUR) and output rate on MD/TD tear ratio of 0.75 mil films made from three dual reactor bimodal single site resins used in the experiments at the blow up ratios of 2.5 and 3.5 and the production rates of 12 lbs/hr/inch (2.1 kg/hr/cm) and 16 lbs/hr/inch (2.8 kg/hr/cm) of die circumference.

FIG. 15 shows the effects of BUR and output rate on puncture energy of 0.75 mil films made from three dual reactor bimodal single site resins used in the experiments at the blow up ratios of 2.5 and 3.5 and the production rates of 12 lbs/hr/inch (2.1 kg/hr/cm) and 16 lbs/hr/inch (2.8 kg/hr/cm) of die circumference.

### DETAILED DESCRIPTION

The polyethylene polymers or resins which may be used in accordance with the present invention typically comprise not less than 60, preferably not less than 70, most preferably not less than 80 weight % of ethylene and the balance of one or more C₃₋₈ alpha olefins, preferably selected from the group consisting of 1-butene, 1-hexene and 1-octene.

The polymers suitable for use in the present invention are generally prepared using a solution polymerization process. Solution processes for the (co)polymerization of ethylene are well known in the art. These processes are conducted in the presence of an inert hydrocarbon solvent typically a C₅₋₁₂ hydrocarbon which may be unsubstituted or substituted by a C₁₋₄ alkyl group, such as pentane, methyl pentane, hexane, heptane, octane, cyclohexane, methylcyclohexane and hydrogenated naphtha. An example of a suitable solvent that is commercially available is “Isopar E” (C₈₋₁₂ aliphatic solvent, Exxon Chemical Co.).

The solution polymerization process for preparing the polymers suitable for use in the present invention must use at least two polymerization reactors one of which should be in tandem to the other. The first polymerization reactor preferably operates at a lower temperature (“cold reactor”) using a “phosphinimine catalyst” described below.

The polymerization temperature in the first reactor is from about 80° C. to about 180° C. (preferably from about 120° C. to 160° C.) and the second reactor or hot reactor is preferably operated at a higher temperature (up to about 220° C.). Most preferably, the second polymerization reactor is operated at a temperature higher than the first reactor by at least 20° C., typically 30 to 80° C., generally 30 to 50° C. The most preferred reaction process is a “medium pressure process”, meaning that the pressure in each reactor is preferably less than about 6,000 psi (about 42,000 kilopascals or kPa), most preferably from about 2,000 psi to 3,000 psi (about 14,000-21,000 kPa).

The monomers are dissolved/dispersed in the solvent either prior to being fed to the first or second reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the first reactor. Additional monomers and solvent may be added to the second reactor, and it may be heated or cooled, preferably heated.

Generally, the catalyst components (i.e. the catalyst and co-catalysts) may be premixed in the solvent for the reaction or fed as separate streams to each reactor. In some instances of premixing it may be desirable to provide a reaction time for the catalyst components prior to entering the reaction. Such an “in line mixing” technique is described in a number of patents in the name of DuPont Canada Inc. (e.g. U.S. Pat. No. 5,589,555, issued Dec. 31, 1996).

The residence time in each reactor will depend on the design and the capacity of the reactor. Generally, the reactors should be operated under conditions to achieve a thorough mixing of the reactants. In addition, it is preferred that from 20 to 60 weight % of the final polymer is polymerized in the first reactor, with the balance being polymerized in the second reactor. On leaving the reactor system, the solvent is removed and the resulting polymer is finished in a conventional manner.

In a highly preferred embodiment, the first polymerization reactor has a smaller volume than the second polymerization reactor.

The polymers useful in accordance with the present invention are prepared in the presence of a phosphinimine catalyst of the formula: 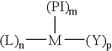
wherein M is a group 4 metal, preferably selected from the group Ti, Zr, and Hf, most preferably Ti; Pl is a phosphinimine ligand; L is a monoanionic ligand selected from the group consisting of a cyclopentadienyl-type ligand; Y is an activatable ligand; m is 1 or 2; n is 0 or 1; and p is an integer and the sum of m+n+p equals the valence state of M.

The phosphinimine ligand has the formula ((R²¹)₃P═N)—wherein each R²¹ is independently selected from the group consisting of C₃₋₆ alkyl radicals. Preferably R²¹ is a t-butyl radical.

Preferably, L is a 5-membered carbon ring having delocalized bonding within the ring and bound to the metal atom through η⁵ bonds and said ligand being unsubstituted or up to fully substituted with one or more substituents selected from the group consisting of C₁₋₁₀ hydrocarbyl radicals which hydrocarbyl substituents are unsubstituted or further substituted by one or more substituents selected from the group consisting of a halogen atom and a C₁₋₈ alkyl radical; a halogen atom; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula Ge—(R)₃ wherein R is as defined above. Most preferably, the cyclopentadienyl type ligand is selected from the group consisting of a cyclopentadienyl radical, an indenyl radical and a fluorenyl radical.

Y is selected from the group consisting of a hydrogen atom; a halogen atom, a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted or further substituted by one or more substituents selected from the group consisting of a halogen atom; a C₁-8 alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals. Most preferably, Y is selected from the group consisting of a hydrogen atom, a chlorine atom and a C₁₋₄ alkyl radical.

The catalysts used to make the polymers useful in the present invention may be activated with different activators.

The catalysts of the present invention may be activated with a co-catalyst selected from the group consisting of:

(i) an aluminoxane compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from 2:1 to 5:1 if the hindered phenol is present;

(ii) an ionic activator that may be selected from the group consisting of:
(A) compounds of the formula [R¹³]⁺ [B(R¹⁴)₄]⁻ wherein B is a boron atom, R¹³ is a cyclic C₅₋₇ aromatic cation or a triphenyl methyl cation and each R¹⁴ is independently selected from the group consisting of phenyl radicals which are unsubstituted or substituted with 3 to 5 substituents selected from the group consisting of a fluorine atom, a C₁₋₄ alkyl or alkoxy radical which is unsubstituted or substituted by a fluorine atom; and a silyl radical of the formula —Si—(R¹⁵)₃; wherein each R¹⁵ is independently selected from the group consisting of a hydrogen atom and a C₁₋₄ alkyl radical; and
(B) compounds of the formula [(R¹⁸)ₜZH]⁺[B(R¹⁴)₄]⁻ wherein B is a boron atom, H is a hydrogen atom, Z is a nitrogen atom or phosphorus atom, t is 2 or 3 and R¹⁸ is selected from the group consisting of C₁₋₈ alkyl radicals, a phenyl radical which is unsubstituted or substituted by up to three C₁₋₄ alkyl radicals, or one R¹⁸ taken together with the nitrogen atom may form an anilinium radical and R¹⁴ is as defined above; and
(C) compounds of the formula B(R¹⁴)₃ wherein R¹⁴ is as defined above; and

(iii) mixtures thereof.

In the present invention the aluminoxane (co-catalyst) and the ionic activator (co-catalyst) may be used separately (e.g. MAO in the first or second reactor and ionic activator in the second or first reactor, or MAO in both reactors or ionic activator in both reactors) or together (e.g. a mixed co-catalyst: MAO and ionic activators in the same reactor (i.e. the first and second reactor)). In one embodiment in the first reactor (e.g. the cold reactor) the co-catalyst could comprise predominantly (e.g. >50 weight % of the co-catalyst) an aluminoxane co-catalyst. The co-catalyst in the cold reactor may also comprise a lesser amount (e.g. <50 weight % of the co-catalyst) of an ionic activator as described above. In this embodiment in the second reactor (e.g. the hot reactor) the activator may comprise a predominant (e.g. >50 weight % of the co-catalyst) amount of an ionic activator. The co-catalyst in the hot reactor may also comprise a lesser amount (e.g. <50 weight % of the co-catalyst) an aluminum based co-catalyst (activator) noted above. In second embodiment the co-catalysts could be the reverse of the above (e.g. predominantly ionic activator in the first reactor and predominantly aluminum based co-catalyst in the second reactor). In another embodiment the co-catalyst could comprise predominantly an aluminoxane co-catalyst in both reactors (e.g. the first and the second reactor). The co-catalyst in the both reactors may also comprise a lesser amount (e.g. <50 weight % of the co-catalyst) of an ionic activator as described above.

The residence time in each reactor will depend on the design and the capacity of the reactor. Generally the reactors should be operated under conditions to achieve a thorough mixing of the reactants. In addition, it is preferred that from 20 to 60 weight % of the final polymer is polymerized in the first reactor, with the balance being polymerized in the second reactor. On leaving the reactor system the solvent is removed and the resulting polymer is finished in a conventional manner.

In a highly preferred embodiment, the first polymerization reactor has a smaller volume than the second polymerization reactor. In addition, the first polymerization reactor is preferably operated at a colder temperature than the second reactor.

Following polymerization (i.e. on leaving the second reactor) the resulting polymer solution is passed through a flasher to flash the solvent. The resulting melt is pelletized and further steam stripped to remove residual solvent and monomers. In accordance with the present invention the polymer should have a melt index (i.e. I₂) less than 2, preferably less than 1, most preferably from 0.4 to 0.9 g/10 minutes as measured according to ASTM D 1238.

The resulting resin may be compounded with typical amounts of antioxidants and heat and light stabilizers such as combinations of hindered phenols and one or more of phosphates, phosphites and phosphonites typically in amounts of less than 0.5 weight % based on the weight of the resin. The resin may also be compounded with process aids, slip aids, anti-blocking agents and other suitable additives. The amount of additives included in the film resin are preferably kept to a minimum in order to minimize the likelihood that such additives could be extracted into the product or application.

The resulting resin may then be converted to a blown film as a monolayer or as a co-extruded multi-layer film. Typically the resin is extruded as a melt and passed through an annular die and is biaxially stretched (e.g. is expanded in the transverse direction by compressed air within the extrudate having a circular cross section and is stretched in the machine direction by increasing the speed of the take off line). The blow up ratio (BUR—how much the diameter of the extrudate is increased in comparison to the die diameter) may be from about 2 to about 4, typically from 2.5 to 3.5. The resins of the present invention have good bubble stability and are largely machine independent in processing. That is, the particular machines upon which the resin is processed do not have to be operated significantly different from the conditions using other resins.

The annular extrudate may be slit and collapsed to form a monolayer or a co-extruded multi-layer film. The resulting film typically has a thickness from about 0.5 to 6 mils, preferably from 0.75 to 3.0, most preferably from about 0.80 to 2.0 mils. The resulting film may be used for wrapping and/or converted to make flexible bags or pouches such as:

Medical solution bag or pouch—it is an application, where film flexibility and good optical properties are highly valued. Flexibility leads to collapsibility, which is necessary in order to ensure proper and complete drainage of the pouch. Good optical properties provide a medical professional to quickly determine that the medical solution is of the proper type and has not deteriorated or become contaminated.

A medical drainage pouch (e.g. a disposable, flexible pouch for the collection of urine or other human waste). It is an application where good optical properties, puncture and split resistance (tear resistance) is highly valued. Good optical properties are important because they allow a medical professional to perform a visual inspection of the fluid collected (e.g. urine). Such a visual inspection allows the medical professional to determine whether the fluid is indeed draining into the pouch, whether blood or sedimentary particles are present in the drainage, the color of the drainage, etc. Good balance of puncture and split resistance is required to contain the excretion products without leakage or rupture.

Packaging films and bags for single use medical supplies (e.g. syringes). An application where good heat sealability properties and puncture resistance are highly valued as the bags may be subjected to high ambient temperatures during shipping. If the seal is not strong it can lead to failure of the bag.

Medical care products and similar medical applications including films for cosmetics products where good optical properties, low hexane extractables, good heat sealability and a good balance of physical properties such as dart impact strength, MD and TD tear strength and puncture resistance are highly valued.

The present invention will now be illustrated by the following non-limiting examples.

Three different ethylene octene bimodal single site LLDPE resins (Resins C, D and E) were made using a titanium complex of titanium one cyclopentadienyl ligand, one tritirtiary butyl phosphinimine ligand and two chlorine atoms (CpTiNP(t-Bu)₃Cl₂) prepared according to the procedures disclosed in Organometallic 1999, 18, 1116-1118. The co-catalyst in the first reactor was methylalumoxane purchased from Akzo-Nobel under the trade name MMAO-7® and the activator in the second reactor was triphenylcarbenium tetrafluorophenyl borate. Dual tandem reactors were used to make the polymers according to the teachings of U.S. Pat. No. 6,372,864 B1. All three resins had essentially similar MI and density, but differed in terms of MWD (molecular weight distribution, Mw/Mn) and, therefore, melt flow ratio (I₂₁/I₂). Two commercial LLDPE resins one made using Z-N catalyst in an ethylene—hexene gas phase process (Resin A) and one made using a Z-N catalyst in an ethylene—octene solution phase process (Resin B) were selected for comparison. Resins A and B had similar melt index and density to resins C, D and E. Table 1 shows the physical characteristics of all the samples used in this study.

Molecular Weight and Co-Monomer Distributions

The average molecular weights and the MWDs were determined using a Waters Model 150 Gel Permeation Chromatography (GPC) apparatus equipped with a differential refractive index detector. The co-monomer distribution of the resins was determined through GPC-FTIR. All of the resins A to E, exhibited normal co-monomer distributions, i.e., the amount of co-monomer incorporated in polymer chains decreased as molecular weight increased.

TABLE 1
Characteristics of Polyethylene Samples

| | Melt | Density | MFR | | Catalyst |
|---|---|---|---|---|---|
| Resin | Index I₂ | kg/m³ | (I₂₁/I₂) | Polydispersity | Type |
| A | 0.50 | 918 | 27.7 | 3.3 | Z-N |
| B | 0.50 | 918 | 31.1 | 3.3 | Z-N |
| C | 0.65 | 918 | 22.9 | 2.4 | Single site |
| D | 0.65 | 918 | 28.8 | 2.8 | Single site |
| E | 0.65 | 918 | 35.5 | 3.8 | Single site |

Film Extrusion
1. Resin Processability and Physical Properties Measurements

The selected resins were extruded into 0.75 mil (19.05 micron) and 1.25 mil (31.75 micron) monolayer films using a 3.5-inch industrial size Macro Blown Film Line with an 8-inch die. The Macro line consisted of a general-purpose 88.9 mm (3.5 inch) barrier flight screw having L/D=30 and a mixing head. The die had a dual lip air ring and internal bubble cooling (IBC). The die had a 6-port spiral mandrel with inner bore heating and was designed for IBC. The resins were extruded into films at two different blowup ratios (BUR=2.5 and 3.5) using different output rates, 12 lbs/hr/inch (2.1 kg/hr/cm) and 16 lbs/hr/inch (2.8 kg/hr/cm) of die circumference and it was ensured that the films were free of melt fracture. A constant frost line height was maintained irrespective of changes in BUR and film gauge. The films were conditioned for a minimum of 48 hours under controlled environmental conditions before measuring dart impact, tear strengths, and puncture resistance. ASTM procedure D 1709-01 Method A was used for the measurements of the dart impact strength using a phenolic dart head. ASTM D 1922-03a procedure was used to measure the Elmendorf tear strengths of the films. The puncture resistance was measured using an in-house NOVA Chemicals procedure. In this procedure, the energy required to puncture a polyethylene film is measured using a ¾ inch diameter round faced probe at a 20-inch/minute-puncture rate.

2. Optical Properties, Heat Sealability and Hexane Extractables Measurements

The selected resins were extruded into monolayer films using a Gloucester Blown Film Line with a 4-inch die. The Gloucester line consisted of a general-purpose 53.8 mm (2.12 inch) barrier screw having L/D=30. The die had a dual lip air ring. The die had a 4-port spiral mandrel with inner bore heating. The resins were extruded into films at a blowup ratio (BUR) of 2.5 using an output rate of 6 lbs/hr/inch (1 kg/hr/cm) of die circumference and it was ensured that the films were free of melt fracture. The films were conditioned for a minimum of 48 hours under controlled environmental conditions before measuring Haze (%), Gloss 45°, Hexane Extractables, Hot Tack Strength and Cold Seal Strength. ASTM procedure D1003 was used for the measurement of the Haze. ASTM procedure D2457-03 was used for the measurement of the Gloss 45°. ASTM procedure D5227-01, compliant with Code of Federal Regulations (US Federal Register, Code of Federal Regulations, Title 21, Parts 177.1520) was used for the measurement of the Hexane Extractables. ASTM procedure F1921 was used for the measurement of the Hot Tack Strength on JB Topwave™ Hot Tack Tester. To determine hot tack strength, one-inch (25.4 mm) wide strips were mounted on a Topwave™ Hot tack tester at seal time of 0.5 s, cool time of 0.5 s, peel speed of 500 mm/s and seal pressure of 0.27 N/mm². Three specimens were tested at each temperature and average results are reported. Hot tack strength is recorded in Newtons (N)/inch width. To determine cold seal strength, filmstrips were cut in the machine direction. Each specimen was placed in a JB Topwave™ Hot Tack Tester and sealed to itself using a seal bar pressure of 0.27 N/mm². Five specimens were prepared at each temperature. The sealed specimens were conditioned at room temperature for at least 24 hours and then pulled on Instrument five head universal tester at the rate of 20 in/min. Average values of five specimens are reported. Cold Seal strength is recorded in Newtons (N)/0.5 inch width.

A Rosand capillary rheometer with tensile module attachment was used for the measurement of melt strength for all the samples.

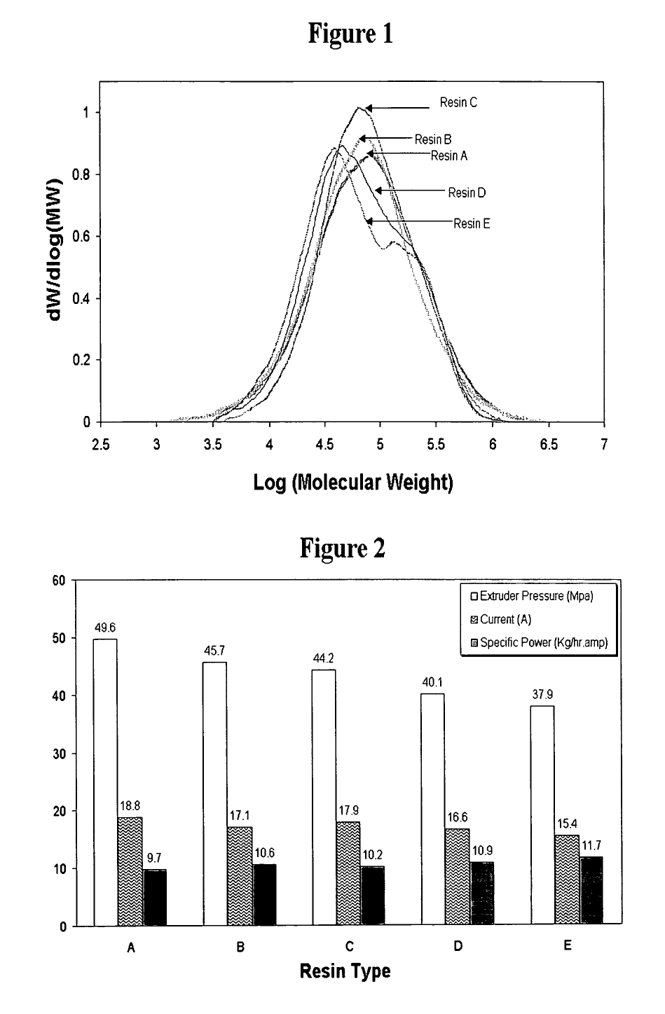

FIG. 1 shows the GPC profiles for Resins A to E. Resins A and B show the expected unimodal MWDs. Resins C, D and E showed different MWDs depending on the molecular weight and amount of polymer produced in each reactor. The MWDs of resins C, D and E are consistent with their polydispersity and MFR measurements as shown in Table 1.

FIG. 2 depicts the processing characteristics of Resins A to E. As expected, the extrusion pressure for resins C, D and E decreases as the polydispersity or the MFR increases. The extrusion pressure for resins A and B is also consistent with their MFR values. Resin E showed the lowest extrusion pressure and extruder current, and provided the highest specific power (kg/hr/amp) among all, due to its higher MFR and lower viscosity. The extrusion melt temperatures of resins C, D and E were found to be 5 to 8° C. lower than resins A and B. This drop in melt temperature provided equivalent bubble stability for resins C, D, and E compared to resins A and B, even though resins C, D, and E had slightly lower melt strength (4 versus 5 cN for resins A and B at equivalent temperature of 190° C.).

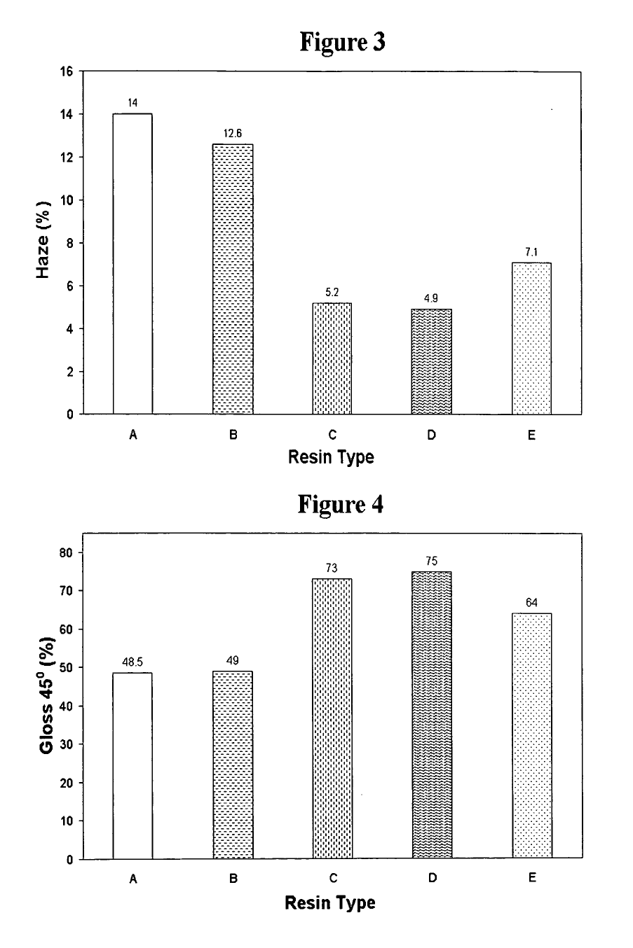

FIG. 3 shows the Haze (%) values for the 0.75 mil films made from Resins A to E at 2.5 BUR. The films made using dual reactor single site resins C, D and E show lower haze (%) values compared to Z-N resins A and B. The broadest MFR dual reactor single site resin E has more than 40% lower haze than the conventional Z-N resins A and B. However, when the MFR of the dual reactor single site catalyst resins was narrowed, the haze (%) further decreased substantially with resin D having the lowest haze of 4.9% followed by resin C at 5.2%.

FIG. 4 shows the Gloss 45° for the 0.75-mil films made from Resins A to E at 2.5 BUR. The films made using dual reactor single site resins C, D and E show higher Gloss 45° values compared to Z-N resins A and B. The broadest MFR bimodal resin E has more than 25% higher gloss 45° than the conventional Z-N resins A and B. However, when the MFR of the dual reactor single site catalyst resins was narrowed, the gloss 45° further increased with a peak value achieved for resin D. It is important to note that, at essentially similar MFR and density values, the film made from the dual reactor single site resin D has gloss 45° value of 75% compared to a gloss 45° value of 49% achieved for the film made from the Z-N resin A.

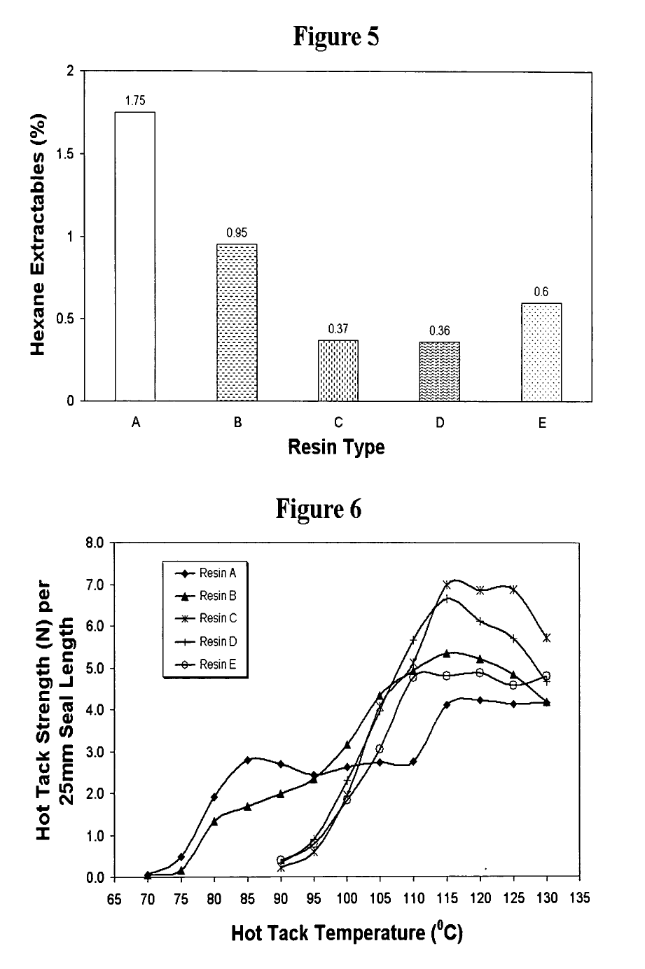

FIG. 5 shows the hexane extractables (%) for 3.5 mil films made from Resins A to E. Dual reactor single site resins C, D and E show substantially lower hexane extractables (%) compared to the Z-N resins A and B. Very low hexane extractables of 0.36% are achieved for the film made from resin D with an MFR value of 28.8.

FIG. 6 shows the Hot Tack Strength profiles of 2.0 mil films made from the Resins A to E. Hot tack strength is the force, measured in Newtons, required to separate a hot bi-layer film seal. At a temperature of about 115° C., dual reactor single site resins C and D show peak hot tack strengths that are more than 25% higher compared to the conventional Z-N resins, A and B. High hot tack strength is desired for example, in form-fill and seal applications, where the package contents are dropped into a bag while the seal is still hot. Since the contents can be heavy and are packaged at high speed, the high hot tack strength is desirable so that it can withstand a certain load at a high loading rate while the seal is still hot. The broad MFR resin E has lower hot tack strength that is somewhat comparable to the conventional Z-N catalyzed resins.

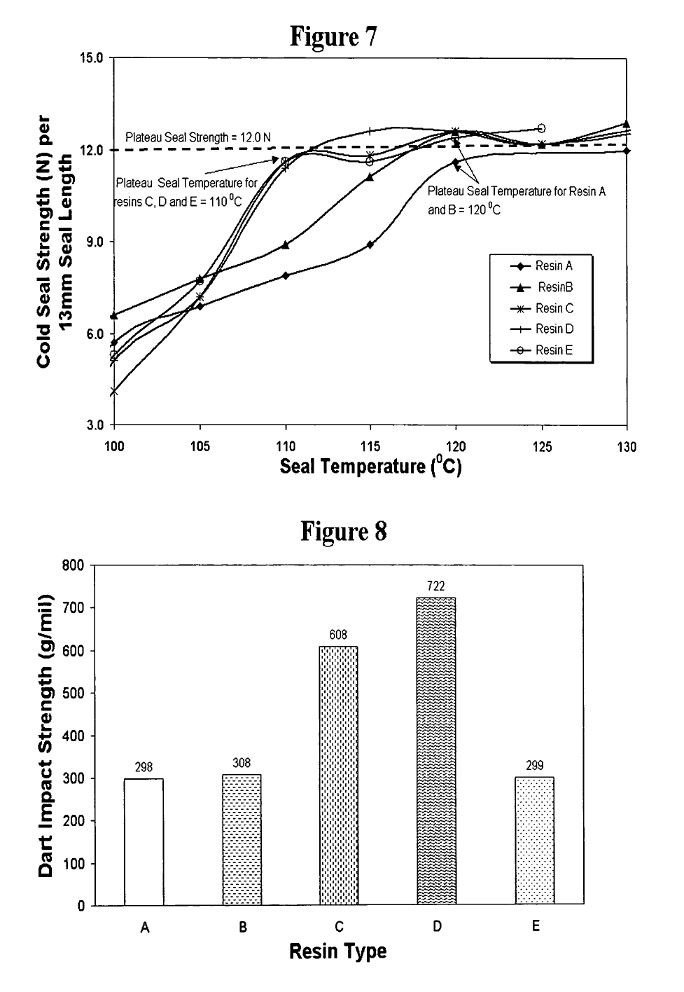

FIG. 7 shows the Cold Seal profiles of 2.0 mil films made from the Resins A to E. As seen in FIG. 7, as the Seal Temperature is increased the Force to open the seal increases until a plateau is reached after which the force required to open the seal does not increase significantly with further increase in seal temperature. This can be referred to as “plateau seal strength”. The plateau seal strength for all the resins (Resins A to E) was similar at about 12 N. However, there is a significant difference in the temperature at which the plateau seal strength is achieved. The dual reactor single site resins C, D and E achieve the plateau seal strength at about 110° C. compared to about 120° C. required for the conventional Z-N Resins A and B. Sealing the bags and/or pouches at lower temperature, while maintaining the same cold seal strength, may lead to significant energy savings and/or faster cycle times with the dual reactor single site resins C, D and E compared to the conventional Z-N resins A and B.

FIG. 8 shows the Dart Impact Strengths of the 0.75 mil films made at 2.5 BUR and 16 lbs/hr/inch (2.8 kg/hr/cm) of die circumference output rate for all the resins. It is seen from this figure that the broadest MWD (MFR=35.5) bimodal resin E, provides similar Dart Impact values as obtained with the two Z-N catalyzed resins A and B. However, when the MWD of the dual reactor single site catalyzed bimodal LLDPE resins was narrowed, the Dart Impact Strength substantially increased with the peak value achieved for resin D with MFR value of 28.8. It is interesting to note that at essentially similar MFR values, the bimodal resin D provided Dart Impact Strength that was more than double the value achieved for the Z-N catalyzed resins A and B.

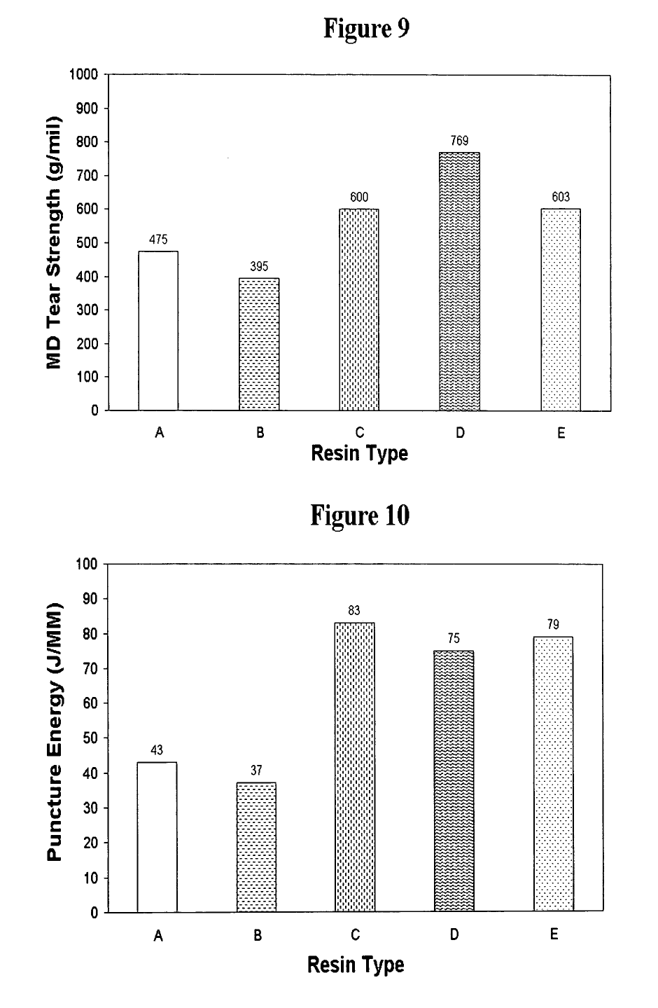

FIG. 9 depicts the Machine Direction (MD) Tear Strengths for the same film samples. The single site catalyzed dual reactor bimodal LLDPE resins C, D and E all showed higher MD Tear Strengths compared to the Z-N catalyzed unimodal Resins A and B. Furthermore, the MD Tear strength peaked for LLDPE resin D with MFR value of 28.8 that also showed low haze and low hexane extractables, high gloss 45°, high dart Impact strength and excellent hot tack and cold seal strength properties.

FIG. 10 illustrates a comparison of Puncture Energy required to break the films for all the resins. The films made from the dual reactor single site catalyzed bimodal LLDPE resins C, D and E showed significantly higher values of Puncture Energy required as compared to the Z-N catalyzed resin (A and B) film samples. For bimodal LLDPE films the Puncture Energy appeared to be relatively insensitive to MWD of the resins. Essentially similar trends in Dart Impact and MD Tear Strengths and Puncture Energy were obtained for the 1.25 mil films blown at 2.5 BUR and 16 lbs/hr/inch (2.8 kg/hr/cm) of die circumference output rate. These results show that the dual reactor single site catalyzed bimodal LLDPE resins can provide superior film physical properties and excellent processing characteristics compared to the Z-N catalyzed resins processed under similar conditions (BUR and output rate). This should allow the film processors to achieve significantly higher film performance with dual reactor single site catalyzed bimodal LLDPE resins. Alternatively, it may be possible to down gage the film thickness with dual reactor single site bimodal LLDPE resins and achieve similar film properties as realized with the conventional Z-N catalyzed resins.

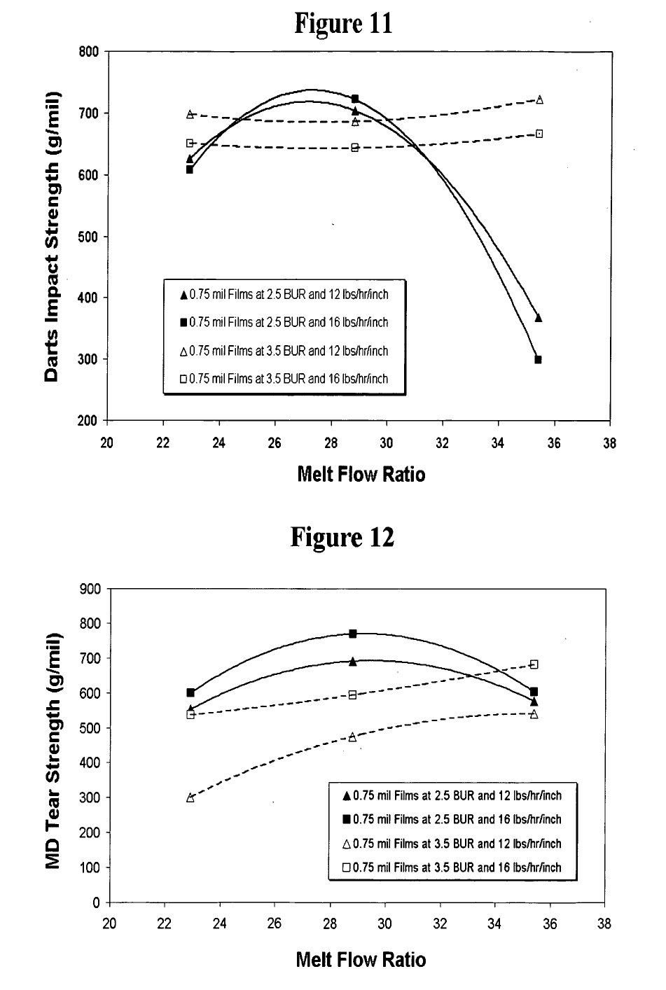

FIG. 11 shows the Dart Impact Strengths of films at two different BURs and output rates as a function of MFR of different resins (C, D and E). For films made at 2.5 BUR, it appears that high values of Dart Impact Strength are achieved when the MFR of the resin is between 25 and 30 and these values are essentially independent of the extruder output rates. At 3.5 BUR, however, high values of Dart Impact Strength are achieved with the dual reactor single site LLDPE resins (C, D and E) irrespective of their MWD (in the MFR range of 22.8 to 35.5 that was examined in this study). Furthermore, at 3.5 BUR, a slight decrease in Dart Impact Strength was seen as extruder output was increased from 12 lbs/hr/inch (2.1 kg/hr/cm) to 16 lbs/hr/inch (2.8 kg/hr/cm) of die circumference. These results indicate that the molecular orientation and, perhaps more importantly, the resulting morphology (crystallite number, size and its orientation) play important roles in determining the Dart Impact Strength of films made with different MWD resins under different processing conditions.

FIG. 12 illustrates the effect of BUR and extruder output rates on the MD Tear Strength of the 0.75-mil films made with dual reactor single site LLDPE resins (C, D and E) having different MFR values. At 2.5 BUR, it appears that resin D with MFR value of 28.8 gives the maximum value of MD Tear Strength. At 3.5 BUR, however, MD Tear Strength increases with an increase in resin MFR. In all cases, MD Tear Strength of films increased with an increase in extruder output rate. This result is somewhat surprising and opposite in relation to the observations generally made with the conventional Z-N catalyzed resins (and with LLDPE/LDPE blends) where an increase in output rates is thought to impart higher molecular orientation thus reducing machine direction tear strength. It implies that dual reactor single site catalyzed, bimodal LLDPE resins (C, D and E) exhibit very different film morphology than the films made with the conventional Z-N catalyzed resins, and, therefore, previous understanding of the role of molecular orientation on film physical properties needs to be re-examined in relation to the unique film morphological attributes in dual reactor bimodal single site catalyzed LLDPE resins.

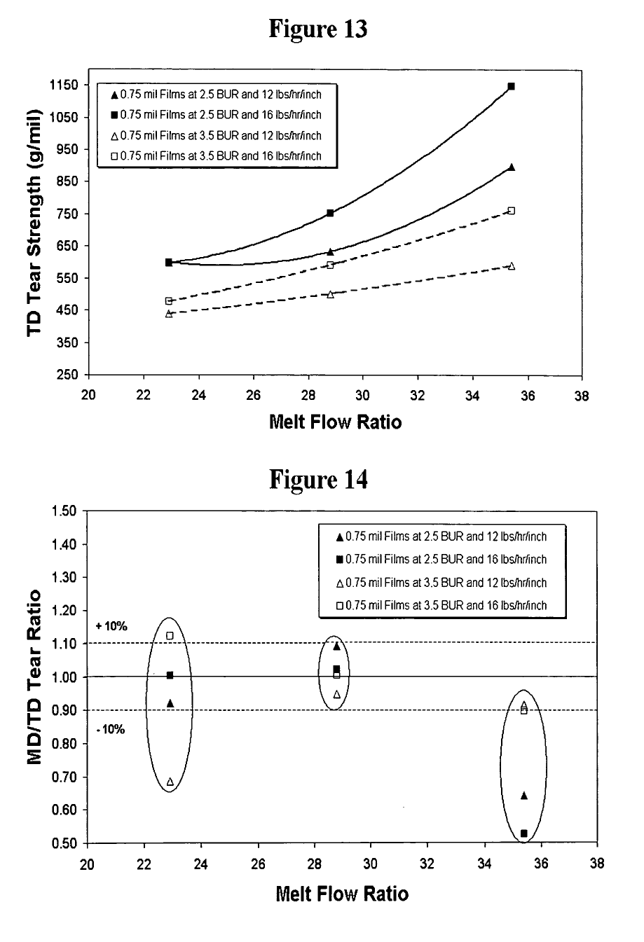

FIG. 13 depicts the effects of BUR and output rates on the Transverse Direction (TD) Tear Strength for various dual reactor single site catalyzed LLDPE resins (C, D and E). This figure shows that the TD Tear Strength of films made from dual reactor bimodal single site catalyzed LLDPE increases with an increase in resin MFR and extruder output rates. Furthermore, TD Tear Strength also increases with a decrease in BUR. Higher molecular orientation under these conditions is believed to increase TD Tear Strengths in these films.

FIG. 14 provides the MD/TD Tear Ratios for the 0.75-mil films made under different BURs and output rates using various dual reactor bimodal single site catalyzed LLDPE resins having different MFR values. MD/TD Tear Ratio of 1.0 indicates a good balance of tear strength in both directions. This figure shows that Resin D having MFR of 28.8 provides a very good balance of Tear Strengths (within±10%) in both directions and the MD/TD Tear ratio is relatively insensitive to the processing conditions (BUR and output rates). From a film processor's viewpoint, this is a very good feature to have, since it eliminates the line-to-line dependency on film tear balance. Whereas, for resins C and E having lower and higher MFR values than resin D, the line conditions would need to be optimized to achieve a better balance in tear properties.

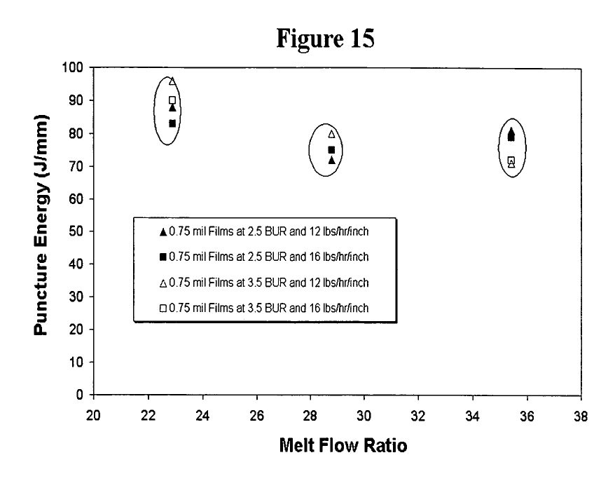

FIG. 15 shows the Puncture Energy required to break the films made under different processing conditions using various dual reactor single site catalyzed bimodal LLDPE resins (C, D and E). The processing conditions (BUR and output rate) seem to have little influence on Puncture Energy of film for a particular resin. Resin C with the lowest MFR appear to provide slightly higher values of Puncture Energy under all processing conditions that were used here.

The results show that the dual reactor bimodal single site catalyzed LLDPE resins (C, D and E) exhibit superior film physical properties, excellent resin processability and optical properties compared to comparable films made using conventional Z-N catalyzed resins (A and B). The dual reactor bimodal single site catalyzed LLDPE resins having a MFR between 23 and 32, preferably between 25 and 30 provide low hexane extractables, good optical properties (low haze and high gloss), good heat sealability, good puncture resistance, and good dart impact and MD tear strengths and balanced tear strengths in both the MD and TD directions. Furthermore, the film properties are found to be relatively insensitive to processing conditions.

1. A medical packaging film, bag or pouch made from a linear low density polyethylene having a density from 0.914 to 0.945 g/cm³ and a melt flow ratio (MFR (I₂₁/I₂) determined according to ASTM D 1238) from 23 to 32 prepared by A) polymerizing ethylene optionally with one or more C₃₋₁₂ alpha olefins, in solvent in a first stirred polymerization reactor at a temperature of from 80 to 200° C. and a pressure of from 10,500 to 35,000 KPa, (1,500 to 5,000 psi) in the presence of (a) a catalyst which is an organometallic complex of a group 3, 4 or 5 metal, characterized by having at least one phosphinimine ligand; and (b) co-catalyst selected from the group consisting of:
(i) an aluminoxane compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from 2:1 to 5:1 if the hindered phenol is present;
(ii) an ionic activator that may be selected from the group consisting of:
(A) compounds of the formula [R¹³]⁺ [B(R¹⁴)₄]⁻ wherein B is a boron atom, R¹³ is a cyclic C₅₋₇ aromatic cation or a triphenyl methyl cation and each R¹⁴ is independently selected from the group consisting of phenyl radicals which are unsubstituted or substituted with 3 to 5 substituents selected from the group consisting of a fluorine atom, a C₁₋₄ alkyl or alkoxy radical which is unsubstituted or substituted by a fluorine atom; and a silyl radical of the formula —Si—(R¹⁵)₃; wherein each R¹⁵ is independently selected from the group consisting of a hydrogen atom and a C₁₋₄ alkyl radical; and
(B) compounds of the formula [(R¹⁸)ₜZH]⁺[B(R¹⁴)₄]⁻ wherein B is a boron atom, H is a hydrogen atom, Z is a nitrogen atom or phosphorus atom, t is 2 or 3 and R¹⁸ is selected from the group consisting of C₁₋₈ alkyl radicals, a phenyl radical which is unsubstituted or substituted by up to three C₁₋₄ alkyl radicals, or one R¹⁸ taken together with the nitrogen atom may form an anilinium radical and R¹⁴ is as defined above; and
(C) compounds of the formula B(R¹⁴)₃ wherein R¹⁴ is as defined above; and
(iii) mixtures thereof; and
B) passing said first polymer solution into a second stirred polymerization reactor at a pressure from 10,500 to 35,000 KPa (1,500 to 5,000 psi) and a temperature at least 20° C. higher than the first reactor and polymerizing further ethylene, optionally with one or more C₃₋₁₂ alpha olefins, in said second stirred polymerization reactor in the presence of (a) a catalyst which is an organometallic complex of a group 3, 4 or 5 metal, characterized by having at least one phosphinimine ligand; and (b) a co-catalyst as described above; said polyethylene, having a melt index less than 2 as measured by ASTM D 1238, when formed into a monolayer or a co-extruded multi-layer film at a blowup ratio from 2 to 4 and a thickness from 0.5 to 6 mils using a blown film line at a production rate that is greater than 6 lbs/hr/inch (1 kg/hr/cm) of die circumference, has haze values 59 to 65% lower, gloss 45° values 49 to 55% higher, hexane extractables 58 to 79% lower, a plateau seal temperature of about 110° C., hot tack strength (at 115° C.) 25 to 70% higher, dart impact strengths 97 to 142% higher, machine direction (MD) tear strengths 26 to 95% higher, and puncture energy values 74 to 124% higher than films made from resin produced by conventional Ziegler-Natta catalysis, wherein the conventional Ziegler-Natta resin has a melt index of up to 0.15 g/10 min lower than the melt index of the linear low density polyethylene prepared according to said steps A) and B.

2. A film, bag or pouch according to claim 1, wherein said polyethylene is polymerized in the presence of a catalyst of the formula: 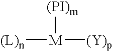
wherein M is a group 4 metal; Pl is a phosphinimine ligand; L is a monoanionic ligand selected from the group consisting of a cyclopentadienyl-type ligand; Y is a ligand selected from the group consisting of a hydrogen atom, a halogen atom, and a C₁₋₄ alkyl radical; m is 1 or 2; n is 0 or 1; and p is an integer and the sum of m+n+p equals the valence state of M.

3. The film, bag or pouch according to claim 2, wherein the second reactor is 30 to 80° C. hotter than the first reactor.

4. The film, bag or pouch according to claim 3, wherein in the catalyst the cyclopentadienyl ligand is selected from the group consisting of a cyclopentadienyl radical, an indenyl radical and a fluorenyl radical.

5. The film, bag or pouch according to claim 4, wherein in the catalyst the phosphinimine ligand has the formula ((R²¹)₃P═N)—wherein each R²¹ is independently selected from the group consisting of C₃₋₆ alkyl radicals.

6. (canceled)

7. The film, bag or pouch according to claim 5 , wherein the polyethylene has a melt flow ratio (MFR (I₂₁/I₂)) as determined according to ASTM D 1238 from 25 to 30.

8. The film, bag or pouch according to claim 7, wherein the polyethylene is formed into a film at a blowup ratio from 2.5 to 3.5 and a thickness from 0.75 to 3 mils at a production rate greater than 6 lbs/hr/inch (1 kg/hr/cm) and up to 30 lbs/hr/inch (5.3 kg/hr/cm) of die circumference.

9. A bag according to claim 8, which is a medical solution bag or pouch.

10. A film according to claim 8, which is a medical supplies' over wrap.

11. A bag according to claim 8, which is a medical drainage bag or pouch.

12. A film according to claim 8, which is a medical hygiene film.

13. A bag according to claim 8, which is a medical packaging or supply bag.

14. A bag according to claim 8, which is a medical-care products bag.

15. A bag according to claim 8, which is a cosmetics packaging or supply bag.

16. A film, bag or pouch according to claim 5, wherein said resin is polymerized in said first reactor in the presence of a co-catalyst comprising a predominant amount of a complex aluminum compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from 2:1 to 5:1 if the hindered phenol is present.

17. A film, bag or pouch according to claim 16, wherein said resin is polymerized in said first and second reactors in the presence of a co-catalyst comprising an ionic activator selected from the group consisting of:
(A) compounds of the formula [R¹³]⁺ [B(R¹⁴)₄]⁻ wherein B is a boron atom, R¹³ is a cyclic C₅₋₇ aromatic cation or a triphenyl methyl cation and each R¹⁴ is independently selected from the group consisting of phenyl radicals which are unsubstituted or substituted with 3 to 5 substituents selected from the group consisting of a fluorine atom, a C₁₋₄ alkyl or alkoxy radical which is unsubstituted or substituted by a fluorine atom; and a silyl radical of the formula —Si—(R¹⁵)₃; wherein each R¹⁵ is independently selected from the group consisting of a hydrogen atom and a C₁₋₄ alkyl radical; and
(B) compounds of the formula [(R¹⁸)ₜZH]⁺[B(R¹⁴)₄]⁻ wherein B is a boron atom, H is a hydrogen atom, Z is a nitrogen atom or phosphorus atom, t is 2 or 3 and R¹⁸ is selected from the group consisting of C₁₋₈ alkyl radicals, a phenyl radical which is unsubstituted or substituted by up to three C₁₋₄ alkyl radicals, or one R¹⁸ taken together with the nitrogen atom may form an anilinium radical and R¹⁴ is as defined above; and
(C) compounds of the formula B(R¹⁴)₃ wherein R¹⁴ is as defined above.

18. The film, bag or pouch according to claim 17, wherein the polyethylene has a melt flow ratio (MFR (I₂₁/I₂)) as determined according to ASTM D 1238 from 25 to 30.

19. The film, bag or pouch according to claim 18, wherein the polyethylene is formed into a film at a blowup ratio from 2.5 to 3.5 and a thickness from 0.75 to 3 mils at a production rate greater than 6 lbs/hr/inch (1 kg/hr/cm) and up to 30 lbs/hr/inch (5.3 kg/hr/cm) of die circumference.

20. A bag according to claim 19, which is a medical solution bag or pouch.

21. A film according to claim 19, which is a medical supplies' over wrap.

22. A bag according to claim 19, which is a medical drainage bag or pouch.

23. A film according to claim 19, which is a medical hygiene film.

24. A bag according to claim 19, which is a medical packaging or supply bag.

25. A bag according to claim 19, which is a medical-care products bag.

26. A bag according to claim 19, which is a cosmetics packaging or supply bag.
